(19) United States
(12) Patent Application Publication
(10) Pub. No.: US 2025/0192464 A1
(43) Pub. Date: Jun. 12, 2025

(54) TERMINAL CONTACT MEMBER, TERMINAL AND ELECTRICAL CONNECTION DEVICE

(71) Applicant: Tyco Electronics (Shanghai) Co., Ltd., Shanghai (CN)

(72) Inventors: Aibing (Alan) Dong, Shanghai (CN); Liqiang (Gino) Yao, Shanghai (CN); Yong (Chris) Wang, Shanghai (CN); Yingchun (David) Wang, Shanghai (CN); Yuquan (Kenny) Chen, Shanghai (CN)

(73) Assignee: Tyco Electronics (Shanghai) Co., Ltd., Shanghai (CN)

(21) Appl. No.: 18/971,154

(22) Filed: Dec. 6, 2024

(30) Foreign Application Priority Data
Dec. 8, 2023 (CN) 202323354315.X

(51) Int. Cl. H01R 13/11

(52) U.S. Cl. CPC H01R 13/111

(57) ABSTRACT

A terminal contact member includes a pair of end rings and a plurality of elastic arms. Each end ring is at an axial end of the terminal contact member. The elastic arms are connected between the end rings and distributed at intervals in a circumferential direction. Each elastic arm has elastic contact segments connected in series in an axial direction of the terminal contact member and an arc-shaped support segment connected between two adjacent elastic contact segments. The end rings and all arc-shaped support segments electrically contact an inner peripheral surface of a terminal body to increase the electrical contact area between the terminal contact member and the inner peripheral surface. The elastic contact segments of each elastic arm electrically contact an outer peripheral surface of a mating terminal, forming multiple electrical contact points between each elastic arm and the mating terminal.

### CROSS-REFERENCE TO RELATED APPLICATION

This application claims the benefit of the filing date under 35 U.S.C. § 119(a)-(d) of Chinese Patent Application No. 202323354315.X filed on Dec. 8, 2023.

### FIELD OF THE INVENTION

The present invention relates to a terminal contact member, a terminal, and an electrical connection device and, more particularly, to a terminal comprising the terminal contact member and an electrical connection device comprising the terminal.

### BACKGROUND OF THE INVENTION

In the prior art, a female terminal in an electrical connector may include a terminal body and a terminal contact member assembled into the terminal body. The terminal contact member is usually cage shaped (or referred to as a crown spring) and inserted into the inner cavity of the terminal body for electrical contact with an inserted male terminal. The terminal contact member, as the bridge and hub connecting male and female terminals in electrical connectors, are the most important component in the entire electrical connector. Under the current technological background, especially in the process of high current transmission, the terminal contact member is an essential and important component. Most of the elastic arms of existing terminal contact members are single arch shaped, with the highest point of the arch electrically contacting the outer surface of the male terminal, and the annular portions at both ends of the existing terminal contact member electrically contacting the inner surface of terminal body. At the same size, the existing terminal contact member has relatively fewer electrical contact points and a smaller electrical contact area, which results in higher contact resistance and higher temperature rise of the electrical connector when passing through rated current.

### SUMMARY OF THE INVENTION

A terminal contact member includes a pair of end rings and a plurality of elastic arms. Each end ring is at an axial end of the terminal contact member. The elastic arms are connected between the end rings and distributed at intervals in a circumferential direction. Each elastic arm has elastic contact segments connected in series in an axial direction of the terminal contact member and an arc-shaped support segment connected between two adjacent elastic contact segments. The end rings and all arc-shaped support segments electrically contact an inner peripheral surface of a terminal body to increase the electrical contact area between the terminal contact member and the inner peripheral surface. The elastic contact segments of each elastic arm electrically contact an outer peripheral surface of a mating terminal, forming multiple electrical contact points between each elastic arm and the mating terminal.

### BRIEF DESCRIPTION OF THE DRAWINGS

The invention will now be described by way of example with reference to the accompanying figures, of which:

FIG. 1 is a perspective view of a terminal contact member according to an exemplary embodiment;

FIG. 2 is a sectional view of the terminal contact member of FIG. 1;

FIG. 3 is a sectional view of a terminal having the terminal contact member of FIG. 1 and a terminal body according to an exemplary embodiment;

FIG. 4 is a sectional view of the terminal contact member of FIG. 1 and a mating terminal according to an exemplary embodiment;

FIG. 5 is a sectional view of the terminal of FIG. 3 with the mating terminal of FIG. 4 inserted into the contact member of the terminal; and

FIG. 6 is a sectional view of the terminal body of FIG. 3.

### DETAILED DESCRIPTION

Exemplary embodiments of the present disclosure will be described hereinafter in detail with reference to the attached figures, wherein like reference numerals refer to like elements. The present disclosure may, however, be embodied in many different forms and should not be construed as being limited to the exemplary embodiments set forth herein; rather, these embodiments are provided so that the present disclosure will convey the concept of the disclosure to those skilled in the art.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the figure(s).

As used herein, an element recited in the singular and preceded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

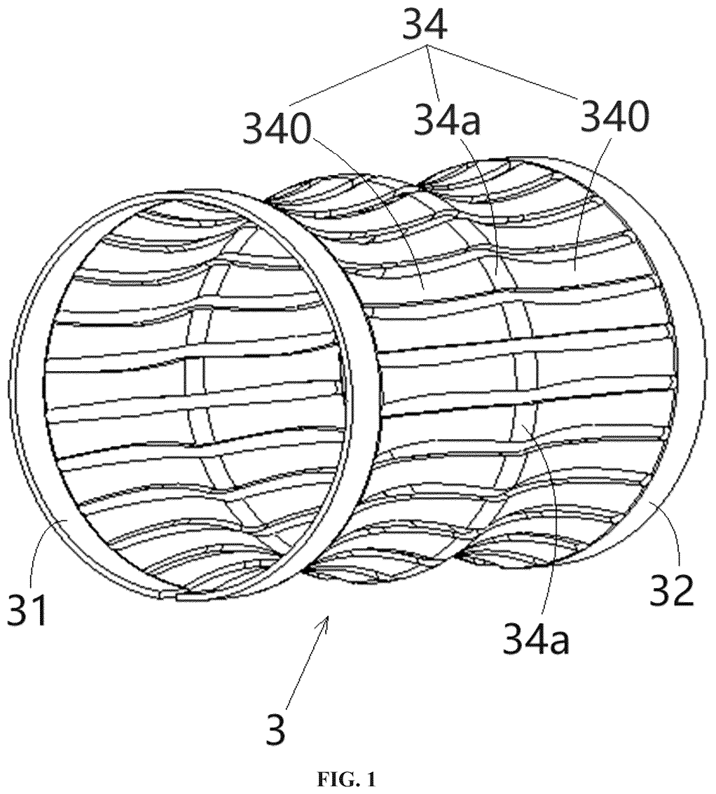

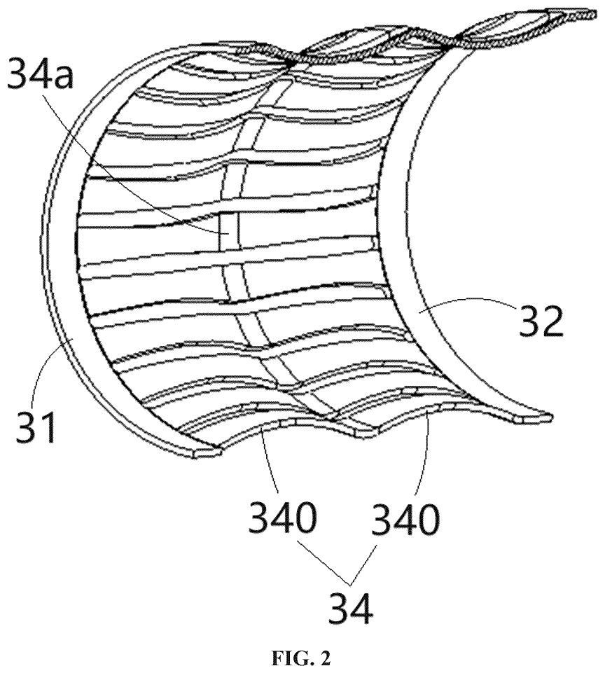

A terminal contact member 3 is now described with reference to FIGS. 1-5. The terminal contact member 3 comprises a pair of end rings 31,32 and a plurality of elastic arms 34. The pair of end rings 31,32 are located at the axial ends of terminal contact member 3, respectively. The plurality of elastic arms 34 are connected between the pair of end rings 31,32 and distributed at intervals in the circumferential direction of the terminal contact member 3. Each elastic arm 34 includes a plurality of elastic contact segments 340 connected in series in the axial direction of the terminal contact member 3, and a arc-shaped support segment 34a. Each arc-shaped support segment 34a of a plurality of arc shaped support segments 34a is connected between two adjacent elastic contact segments 340.

As shown in FIGS. 1-3 and 5, the pair of end rings 31,32 and all arc-shaped support segments 34a are used to make electrical contact with an inner peripheral surface of a terminal body 1, in order to increase the electrical contact area between the terminal contact member 3 and the inner peripheral surface of the terminal body 1. Therefore, the present invention reduces the contact resistance between the terminal contact member 3 and the terminal body 1, resulting in a lower temperature rise of a terminal when passing through the rated current.

As shown in FIGS. 1-5, the plurality of elastic contact segments 340 of each elastic arm 34 are used to make electrical contact with the outer peripheral surface of an inserted mating terminal 2, so that there are multiple electrical contact points between each elastic arm 34 and the mating terminal 2. Therefore, the electrical contact area between the terminal contact member 3 and the mating terminal 2 has been increased, and the contact resistance between the two has been reduced, resulting in a lower temperature rise of the terminal and the mating terminal 2 when passing through the rated current.

As shown in FIGS. 1-3 and 5, each arc-shaped support segment 34a extends along the circumference of the terminal contact member 3, and the plurality of arc-shaped support segments 34a at the same axial position on the plurality of elastic arms 34 are spaced apart and aligned with each other in the circumference of the terminal contact member 3.

As shown in FIGS. 1-3, each elastic arm 34 includes two elastic contact segments 340 connected in series in the axial direction of the terminal contact member 3. Each arc-shaped support segment 34a extends along the circumferential direction of the terminal contact member 3, and each arc-shaped support segments 34a of elastic arms 34 are spaced apart and aligned with each other in the circumferential direction of the terminal contact member 3. However, the present invention is not limited to the illustrated embodiments, for example, each elastic arm 34 may include three or more elastic contact segments 340.

As shown in FIGS. 1-5, the end rings 31,32 have a notch, so that the end rings 31,32 are C-shaped to allow elastic deformation of the end rings 31,32 in their radial direction.

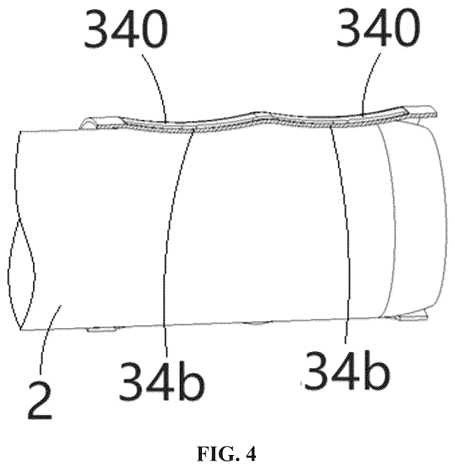

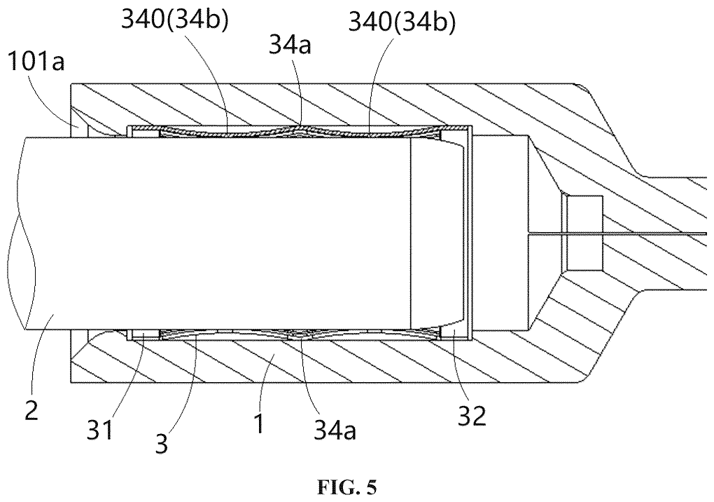

As shown in FIGS. 1-3, each elastic contact segment 340 is arched towards the interior of the terminal contact member 3. A vertex of the elastic contact segment 340 serves as an electrical contact point 34b, as shown in FIGS. 4-5, for electrical contact with the outer peripheral surface of the inserted mating terminal 2, so that each elastic arm 34 has multiple electrical contact points 34b.

As shown in FIGS. 1-3 and 5, the end rings 31,32 and the plurality of arc-shaped support segments 34a have smooth outer surfaces, and the outer surfaces of the end rings 31,32 and the plurality of arc-shaped support segments 34a are used for electrical contact with the inner peripheral surface of the terminal body 1.

As shown in FIGS. 1-5, the terminal contact member 3 is an integral stamped part. This can reduce manufacturing costs and improve manufacturing efficiency.

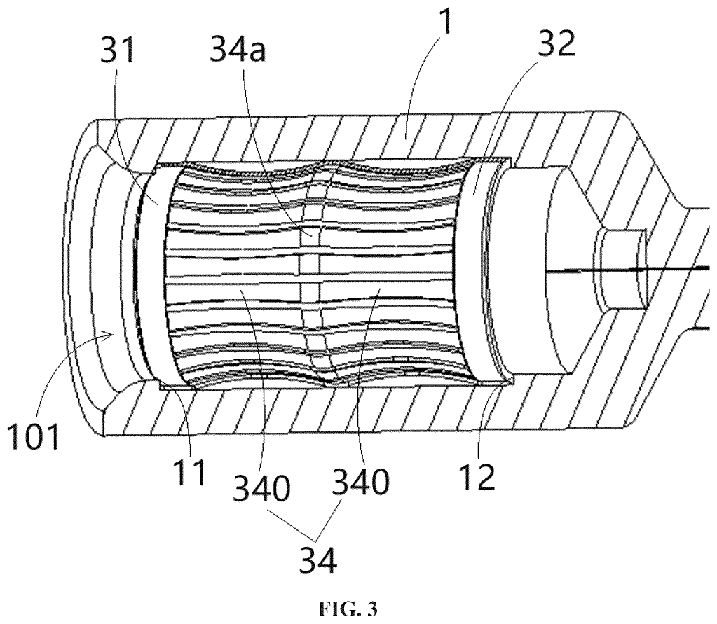

The terminal body 1 has inner cavity 101 that is hollow. The terminal contact member 3 is inserted into the inner cavity 101 of the terminal body 1, as shown in FIGS. 3 and 5. The pair of end rings 31,32 and all arc-shaped support segments 34a of the terminal contact member 3 are in electrical contact with the inner peripheral surface of the terminal body 1 to increase the electrical contact area between the terminal contact member 3 and the inner peripheral surface of the terminal body 1.

As shown in FIG. 3, two annular positioning steps 11,12 are formed in the terminal body 1, and the two annular positioning steps 11,12 are opposite in the axial direction of the terminal body 1. The two annular positioning steps 11,12 are suitable for axially pressing against the end faces of the pair of end rings 31,32 of the terminal contact member 3, respectively, to axially position the terminal contact member 3.

As shown in FIG. 5, the terminal body 1 has an insertion port 101a that allows the mating terminal 2 to be inserted into the terminal contact member 3. The insertion port 101a is in a trumpet shape that flares outward to guide the mating terminal 2 to be inserted into the terminal contact member 3.

As shown in FIG. 3, the two annular positioning steps 11,12 include a first annular positioning step 11 near the insertion port 101a and a second annular positioning step 12 axially opposite to the first annular positioning step 11. The pair of end rings 31,32 include a first end ring 31 and a second end ring 32. The first annular positioning step 11 and the second annular positioning step 12 are axially pressed against the end faces of the first end ring 31 and the second end ring 32, respectively.

As shown in FIGS. 3 and 5-6, the terminal body 1 is an integral piece. For example, it can be an integral machined part or an integral stamped part.

An electrical connection device according to an exemplary embodiment is now described with reference to FIGS. 1-6. The electrical connection device comprises a housing and the terminal as described above. The terminal is installed in the housing.

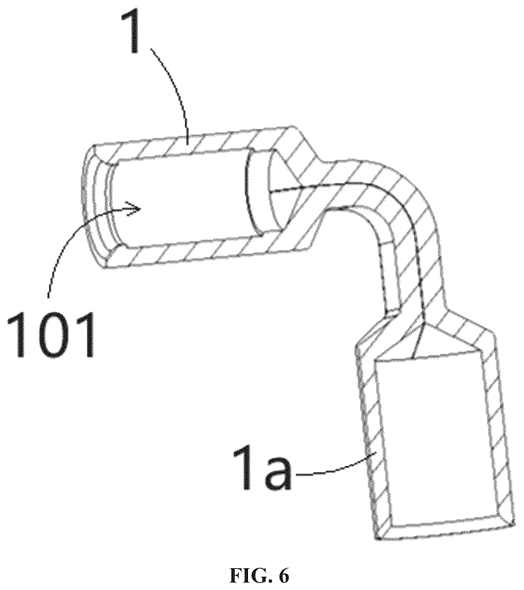

As shown in FIGS. 3 and 5-6, the two ends of the terminal body 1 are perpendicular to each other. The terminal contact member 3 is inserted into the inner cavity 101 of one end of the terminal body 1. The other end of the terminal body 1 is a welding end 1a, shown in FIG. 6, which is used to weld a conductor of a cable to electrically connect the terminal to the cable.

The electrical connection device further comprises a cable. The cable has a conductor and an outer insulation layer wrapped around the conductor. The welding end 1a, as shown in FIG. 6, of the terminal body 1 is tubular and is fitted and welded to one end of the conductor of the cable. The electrical connection device can be a charging seat, a charging gun, or an electrical connector.

It should be appreciated for those skilled in this art that the above embodiments are intended to be illustrative, and not restrictive. For example, many modifications may be made to the above embodiments by those skilled in this art, and various features described in different embodiments may be freely combined with each other without conflicting in configuration or principle.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

In the aforementioned exemplary embodiments according to the present invention, each elastic arm 34 of the terminal contact member 3 has multiple electrical contact points with the inserted mating terminal 2, thereby increasing the electrical contact area between the terminal contact member 3 and the mating terminal 2, reducing the contact resistance between the two, and resulting in a lower temperature rise of the terminal and the mating terminal 2 when passing the rated current.

In addition, in the aforementioned exemplary embodiments according to the present invention, the pair of end rings 31,32 of the terminal contact member 3 and all arc-shaped support segments 34a are in electrical contact with the inner peripheral surface of the terminal body 1, thereby increasing the electrical contact area between the terminal contact member 3 and the terminal body 1, reducing the contact resistance between the two, and resulting in a lower temperature rise of the terminal when passing through the rated current.

1. A terminal contact member, comprising:
a pair of end rings, each end ring is respectively located at an axial end of the terminal contact member; and
a plurality of elastic arms connected between the pair of end rings and distributed at intervals in a circumferential direction of the terminal contact member, each elastic arm has a plurality of elastic contact segments connected in series in an axial direction of the terminal contact member and an arc-shaped support segment of a plurality of arc-shaped support segments connected between two adjacent elastic contact segments, the pair of end rings and the plurality of arc-shaped support segments electrically contact an inner peripheral surface of a terminal body, the plurality of elastic contact segments of each elastic arm electrically contact an outer peripheral surface of a mating terminal to form multiple electrical contact points between each elastic arm and the mating terminal.

2. The terminal contact member of claim 1, wherein the arc-shaped support segments of the elastic arms extend along a circumference of the terminal contact member.

3. The terminal contact member of claim 2, wherein the arc-shaped support segments located at a same axial position on the plurality of elastic arms are spaced apart and aligned with each other along the circumference of the terminal contact member.

4. The terminal contact member of claim 1, wherein each elastic arm has two elastic contact segments connected in series in the axial direction.

5. The terminal contact member of claim 1, wherein the arc-shaped support segments of the elastic arms are spaced apart and aligned with each other in the circumferential direction.

6. The terminal contact member of claim 1, wherein each end ring has a notch forming the end ring as a C-shape, each end ring is elastically deformable in a radial direction.

7. The terminal contact member of claim 1, wherein each elastic contact segment is arched towards an interior of the terminal contact member, and a vertex of each elastic contact segment is an electrical contact point making electrical contact with the outer peripheral surface of the mating terminal.

8. The terminal contact member of claim 1, wherein the pair of end rings and each arc-shaped support segment have outer surfaces that are smooth, the outer surfaces of the pair of end rings and each arc-shaped support segment electrically contact the inner peripheral surface of the terminal body.

9. The terminal contact member of claim 1, wherein the terminal contact member is an integral stamped part.

10. A terminal, comprising:
a terminal body having an inner cavity; and
a terminal contact member disposed in the inner cavity, the terminal contact member including:
a pair of end rings, each end ring is respectively located at an axial end of the terminal contact member; and
a plurality of elastic arms connected between the pair of end rings and distributed at intervals in a circumferential direction of the terminal contact member, each elastic arm has a plurality of elastic contact segments connected in series in an axial direction of the terminal contact member and an arc-shaped support segment of a plurality of arc-shaped support segments connected between two adjacent elastic contact segments, the pair of end rings and the plurality of arc-shaped support segments electrically contact an inner peripheral surface of the terminal body, the plurality of elastic contact segments of each elastic arm electrically contact an outer peripheral surface of a mating terminal to form multiple electrical contact points between each elastic arm and the mating terminal.

11. The terminal of claim 10, wherein a pair of annular positioning steps are formed in the terminal body, the annular positioning steps are opposite one another in the axial direction of the terminal body.

12. The terminal of claim 11, wherein the annular positioning steps respectively rest axially against a pair of end faces of the pair of end rings to axially position the terminal contact member.

13. The terminal of claim 12, wherein the terminal body has an insertion port that receives the mating terminal, the insertion port has a trumpet shape that flares outward to guide an insertion of the mating terminal into the terminal contact member.

14. The terminal of claim 13, wherein the annular positioning steps include a first annular positioning step located near the insertion port and a second annular positioning step axially opposite to the first annular positioning step.

15. The terminal of claim 14, wherein the pair of end rings include a first end ring and a second end ring each having the end faces, the first annular positioning step and the second annular positioning step are respectively axially pressed against the end faces of the first end ring and the second end ring.

16. The terminal of claim 10, wherein the terminal body is an integral piece.

17. An electrical connection device, comprising:
a housing; and
a terminal installed in the housing, the terminal including:
a terminal body having an inner cavity; and
the terminal contact member disposed in the inner cavity of the terminal body, the terminal contact member including:
a pair of end rings, each end ring is respectively located at an axial end of the terminal contact member; and
a plurality of elastic arms connected between the pair of end rings and distributed at intervals in a circumferential direction of the terminal contact member, each elastic arm has a plurality of elastic contact segments connected in series in an axial direction of the terminal contact member and an arc-shaped support segment of a plurality of arc-shaped support segments connected between two adjacent elastic contact segments, the pair of end rings and the plurality of arc-shaped support segments electrically contact an inner peripheral surface of the terminal body, the plurality of elastic contact segments of each elastic arm electrically contact an outer peripheral surface of a mating terminal to form multiple electrical contact points between each elastic arm and the mating terminal.

18. The electrical connection device of claim 17, wherein the terminal body has a welding end welded to a conductor of a cable and electrically connecting the terminal to the cable.

19. The electrical connection device of claim 17, further comprising a cable having a conductor and an outer insulation layer wrapped around the conductor, the terminal body has a welding end, the welding end is tubular and is fitted and welded to an end of the conductor.

20. The electrical connection device of claim 17, wherein the electrical connection device is a charging seat, a charging gun, or an electrical connector.
